(19) United States
(12) Patent Application Publication
(10) Pub. No.: US 2004/0039797 A1
(43) Pub. Date: Feb. 26, 2004

(54) Systems and methods for distributing imaging information using network-based imaging techniques

(76) Inventors: Shell Sterling Simpson, Boise, ID (US); Ward Scott Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/224,735

(22) Filed: Aug. 20, 2002

(51) Int. Cl. G06F 17/00; G06F 15/16

(52) U.S. Cl. 709/219; 707/104.1

(57) ABSTRACT

Systems and methods for distributing imaging information using network-based imaging techniques are disclosed. A system may comprise a server and a computing device coupled to each other via a network. In some embodiments, a network-coupled imaging-destination service operative on the server offers a mechanism for controllably distributing images of documents and/or photographs. A method for distributing imaging information, can be summarized by the following steps: receiving a communication from a client, the communication including an image composition and distribution instructions, identifying the location of the component images comprising the image composition, and distributing the component images of the composition in accordance with the distribution instructions.

### TECHNICAL FIELD

The present disclosure relates to systems and methods for processing digital representations of images. More particularly, the invention relates to systems and methods for distributing imaging information.

### BACKGROUND

As computer technology has advanced, the role of computers in our daily lives has expanded, as has the need for communicating and/or otherwise distributing information between various computers and/or associated data-storage devices. Over the years, a host of peripheral data-processing devices have been devised and commonly used to transfer data, programs, and other information between computers (e.g., keypunch cards, paper tapes, magnetic tapes, floppy disks, read-only memory, etc.).

One significant expansion in the use of computer technology is the networking of computers. Network-coupled computers can communicate with one another, as well as with other devices, such as scanners, cameras, printers, etc. As computer networks, such as the Internet, continue to develop, there is an increasing demand for additional and improved functions that draw upon and exploit the full computing potential of computer networks including the ability to transfer information from one computing device to another computing device.

A common method for distributing information from one network-coupled computing device to another network-coupled computing device uses the File Transfer Protocol (FTP) that is part of the Internet's transmission-control protocol (TCP) and Internet protocol (TCP/IP) protocol suite. TCP enables two computing devices to establish a connection and exchange streams of data. TCP guarantees delivery of data and guarantees that packets will be delivered in the same order in which they were sent. IP, on the other hand, deals only with packets establishing an addressing system without the direct connection.

Technically, an FTP information transfer is not a transfer of information from one location to another, but a file copy from one computer to another. FTP may be used to transfer files across computing devices in proprietary networks, local-area networks (LANs), as well as home networks.

Copying a file from one computer to another has become a relatively common task that can be accomplished in a multitude of ways (e.g., computer to computer network transfer, computer port to computer port transfer, portable-data storage-device enabled transfer, etc.) Of the listed examples, copying files over a network is the often-preferred method.

FTP can be used to both upload and download files (including images and documents) from one computer to another. In the early 1990s, FTP was a popular way for people to upload files and download files from world-wide-web sites operative on the Internet. However, FTP in its basic form is not particularly user friendly, as its use requires a working knowledge of the FTP command structure. Not only does FTP require both an understanding and a working knowledge of its command structure, a user needs to understand and communicate both the source and the destination location for the file to be transferred. Thus, a user of FTP is required to remember sometimes long and confusing paths through complex hierarchical-data storage formats to transfer data. Consequently, for technically perceptive users, FTP is adequate, but for novice and/or unsophisticated computer users, FTP can be quite difficult.

In order to overcome some of the problems with FTP, browser providers have added the capability for a web browser to upload files (i.e., the web browser file upload mechanism). For example, most web-mail applications provide a user with the ability to attach documents to a mail message. These applications generally provide a selectable icon in the form of a pushbutton on a graphical-user interface (GUI) associated with the web-mail application. Upon selection of the pushbutton, the application presents a file open dialog box that allows the user to browse a local data-storage device for a file to upload to a web site. After the user selects a file, the web browser, using hypertext-transfer protocol (HTTP), will copy the file to the web site. The web site may be configured to integrate the file so that it may be selected, viewed, copied, and/or otherwise processed by other users with access authority for the web site and the file.

While this arrangement works well and is much more user friendly than FTP alone, users still need to be able to locate files within the file-management structure used by the host computer. This methodology is still problematic for those users that are unfamiliar with the file-management structure of the host computer. This unfamiliarity may arise when a guest user is operating a computing device, the user simply cannot remember where they stored a file, or when an application creates and stores data in a “default” directory, among others. Consequently, both FTP based and web browser based data transfer methods are problematic when operative on a computing device that uses a hierarchical-file system.

Despite the availability of FTP and web browser based data transfer utilities, it can be appreciated that an improved system and method that avoids one or more of the problems noted above for distributing data between network-coupled computing devices is desired. It should be further appreciated that because a generation of network-based applications have been developed using the aforementioned FTP and web browser based data-transfer utilities, a host of these applications, including applications that receive “uploaded” images, presently require multiple non-intuitive steps and/or can create bandwidth, storage, and management problems for the associated service provider. As the Internet and other networks continue to develop, there is an increasing demand for additional and improved functions that include the ability to controllably distribute information from one computing device to another computing device.

### SUMMARY

Systems and methods for distributing-imaging information to a network-connected computing device have been invented and are disclosed. In some embodiments, a network-coupled imaging-destination service operative on a server offers a mechanism for distributing images of documents and/or photographs. The images may be stored on various devices coupled to the network. An imaging-client-computing device can be used to identify one or more images for inclusion in an image-composition for subsequent uses including controlled distribution. A network-coupled server configured to operate an imaging-distribution service is programmed to receive web content from the imaging-client device via a network, identify a client, an image composition, and distribution instructions. The imaging-distribution service manages the distribution of identified images stored in the client's personal-imaging repository in accordance with the distribution instructions. In these embodiments, the system can be configured to allow a user of the system to direct the distribution of the underlying image information via both destination party, as well as the method and in some cases, time of delivery.

Some embodiments of the system can be viewed as providing methods for controllably distributing information using network-based imaging solutions. In this regard, a method can be summarized by the following steps: receiving a message from a client, the message including information, the information including a client identifier, an image composition identifier, and a client distribution instruction;

managing the image composition; integrating the image composition with a distribution service; and completing the client distribution instruction.

Other systems, methods, and features associated with posting and/or distributing imaging information will become apparent to one with skill in the art upon examination of the following drawings and detailed description. It is intended that all such additional systems, methods, and features included within this description, are within the scope of the systems and methods for distributing imaging information as protected by the accompanying claims.

### BRIEF DESCRIPTION OF THE DRAWINGS

The systems and methods for controllably distributing imaging information can be better understood with reference to the following drawings. The components in the drawings are not necessarily to scale. Emphasis instead is placed upon clearly illustrating the principles of distributing imaging information via a remote-computing device. Furthermore, in the drawings, like reference numerals designate corresponding parts throughout the several views.

FIG. 1 is a schematic illustrating the general operation of a solution for posting imaging information.

FIG. 2 is a schematic diagram illustrating an embodiment of a distributed system in which the system and method for posting imaging information of FIG. 1 may be realized.

FIG. 3 is a first example of an embodiment of a network-based imaging system in which the system and method for posting imaging information of FIG. 1 may be realized.

FIG. 4 is an alternative embodiment of a network-based imaging system in which the system and method for posting imaging information of FIG. 1.

FIG. 5 is a schematic of an embodiment of the imaging-client device shown in FIGS. 3 and 4.

FIGS. 6A and 6B are functional block diagrams illustrating an embodiment of an imaging-source service and an imaging-destination service, respectively of FIGS. 3 and 4.

FIG. 7 is a functional block diagram illustrating an embodiment of a custom hard-copy product destination service in the network-based imaging system of FIGS. 3 and 4.

FIG. 8 is a functional block diagram illustrating an embodiment of an auction-destination service in the network-based imaging system of FIGS. 3 and 4.

FIG. 9 is a functional block diagram illustrating an embodiment of a facsimile-distribution-destination service in the network-based imaging system of FIGS. 3 and 4.

FIG. 10 is a flow diagram illustrating a method for controllably distributing imaging information that may be implemented by the destination services of FIGS. 3-9.

FIG. 11 is a flow diagram illustrating a method for integrating web-based imaging with the facsimile-distribution-destination service of FIG. 9.

### DETAILED DESCRIPTION

Various aspects of the system and method for distributing information using network-based imaging solutions, having been summarized above, reference will now be made in detail to the description of the exemplar systems and methods illustrated in the drawings. While the systems and methods for distributing information will be described concerning these drawings, there is no intent to limit it to the embodiment or embodiments disclosed therein. On the contrary, the intent is to cover all alternatives, modifications, and equivalents included within the scope of the systems and methods for distributing information using network-based imaging solutions as defined by the appended claims.

Generally, the system has a distributed architecture with which a user can maintain data in a personal-imaging repository. Various network-coupled services, including services that generate and store and/or simply store collections of text and graphic images, among other services, may controllably provide data to, or alternatively accept data from, one or more users to compose and/or select an image composition. An image composition includes that information necessary to formulate a representation of the underlying photographs, documents, and/or other information contained in the image(s).

Default compositions or simply “compositions” contain information, such as the contents of a letter or other correspondence that a user of the system desires to integrate to form a product. Alternatively, a default composition may contain the necessary information to identify one or more images, such as photographs processed and stored on a data-storage device coupled to a networked computer. In some arrangements, the various components of a letter formed by a number of images may be stored in a user's personal-imaging repository. The individual images may be referenced by a composition that provides access to one or more services interested in using the images (e.g., photographs, documents, etc.) identified by the composition.

A destination service in the system accesses imaging information available through a user's personal-imaging repository. Conversely, a source service in the system contributes information to a user's personal-imaging repository. This imaging information can be accessed and/or provided in a variety of forms because the imaging information is accessed through a collection of methods (i.e., a programmatic interface) that enables a node in the system (i.e., a personal-imaging repository, a destination service, a source service, and/or a service that acts as both a destination and a source service, among others) to negotiate the preferred form(s) in which it wishes to transfer data. A system node can be a computing device or some other device, such as a router, a printer, a scanner, among others, communicatively coupled with the network. Each node has a unique network address sometimes called a data-link control (DLC) address or a media-access control (MAC) address.

In preferred arrangements, the user identifies and accesses a network-based or web-based imaging service that enables the user to access the imaging data in the user's personal-imaging repository (i.e., a target image file), as well as arrange the imaging data as desired. An imaging-source service does not necessarily have to access a personal-imaging repository before contributing imaging information (including the arrangement of imaging information, which, in a sense, is just another kind of imaging information) to the user's personal-imaging repository. An imaging-source service generates imaging data that is added to the user's personal-imaging repository. This can be accomplished by the user inputting data, the user arranging existing data already in their personal-imaging repository, as well as by other methods. Thus “imaging data” is associated with the user in question, so that imaging-destination services can subsequently use user-specific data. Thereafter, as desired, a network-based imaging server can be accessed to formulate and/or retrieve a desired composition for integration with one or more images stored in the user's personal-imaging repository or within an imaging-client device.

The imaging service may be realized on a local node (i.e., a local-area network-connected device) or a remote node (i.e., a wide-area network-connected device) in the system. In some embodiments, the imaging service may be integrated with a print service or other publishing service such as a photograph developer. As in the case of the imaging service, the photo-developing service may also be realized on local node or a remote node in the system. In other alternative embodiments, an imaging service may be embedded within a print device, an image-acquisition device, such as a digital camera, a digital-video camera, a scanner, among others, or may operate on a server separate and distinct from the print device. It should be appreciated that in the case where the image service is remotely located, the user may be interfacing with a third-party operated service that may provide network-based services in exchange for payment of a fee. For example, the photo developer may develop prints from exposed photographic film, scan the prints, and post the scanned prints on a web site for later distribution by the owner of the photographic film.

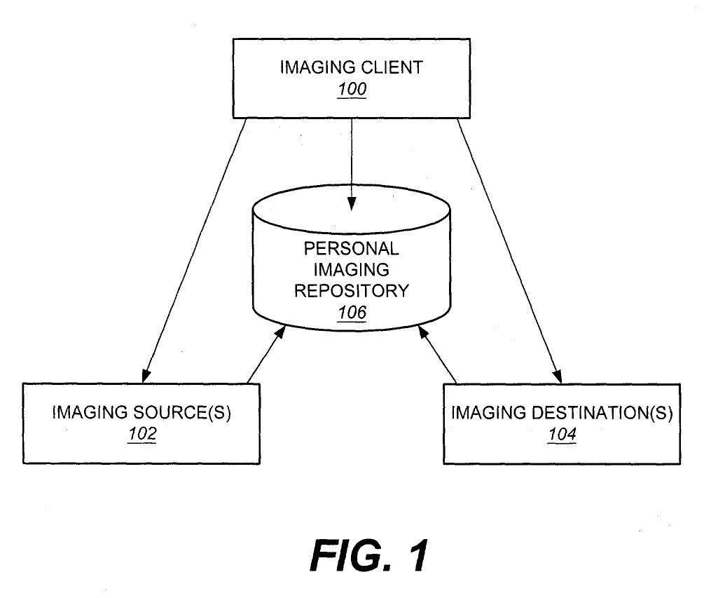

FIG. 1 is a schematic representation of the general operation of the systems and methods for distributing image information. As shown in this figure, an imaging client 100 communicates with one or more imaging sources 102, one or more imaging destinations 104, and a personal-imaging repository 106. The imaging source(s) 102 represent any of a variety of devices/services that can be accessed by the imaging client 100 and used to select or identify imaging data that may be integrated with a previously stored target image (e.g., a text document, a photo, or other images).

The personal-imaging repository 106 provides image storage facilities that typically are personalized for the individual imaging client 100. The imaging repository 106 can be located in various places. For example, the repository 106 can be maintained on one or more computing devices associated with the imaging client 100, imaging source(s) 102, or imaging destination(s) 104. Alternatively, the repository 106 can be maintained on a separate computing device (e.g., a file server) that the imaging client 100, imaging source(s) 102, and imaging destination(s) 104 can access. The data in the imaging repository 106 can be any type of image or graphics-based data, such as text images, video frames, animations, photographs, and/or combinations thereof.

Once data is stored in the personal-imaging repository 106, the imaging client 100 can select data from the repository that is intended to be communicated to the imaging destination(s) 104 for some form of processing or manipulation. By way of example, the data may be transmitted to the image destination(s) 104 for printing and/or displaying or distributing an image of a photograph. In preferred embodiments, the data may include a composition or a set of identifiers identifying both a composition and one or more target images. Where the imaging destination(s) 104 are adapted for printing, they may comprise any of a wide variety of printing devices that are capable of generating hard-copy products, such as printers, multi-function peripherals (MFPs), plotters, services-managing printing devices, and others.

As will be apparent from the discussions that follow, the above-described manner of operation provides a high degree of personalization to the imaging client 100. Specifically, in that the client's personal information can be accessed and utilized with any participating service (e.g., web site) accessible by the client, each accessible service can be “customized” based on the underlying data for each particular user.

The computing device or devices on which the personal-imaging repository 106 is maintained can change dynamically as imaging data is integrated into or removed from the personal-imaging repository 106. The personal-imaging repository 106, might be thought of as the “web” of imaging information (graphics, compositions) associated with the user. Just as the “world-wide-web” changes as new web pages are added and old ones are removed, the personal-imaging repository 106 can also change. An important distinction, however, is that the personal-imaging repository 106 is specific to a particular user. This personalization, however, does not preclude the possibility that imaging data will be integrated into more than one user's personal-imaging repository 106.

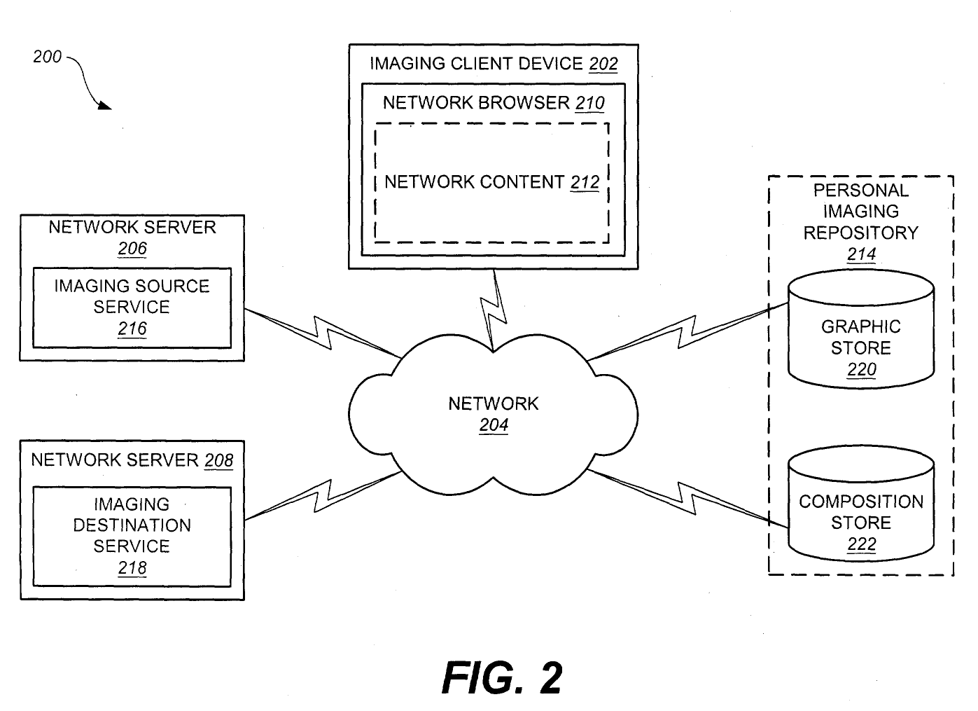

FIG. 2 illustrates an exemplar-distributed system 200 in which the systems and methods for distributing imaging information can be implemented. As indicated in FIG. 2, the system 200 includes an imaging-client device 202 that is coupled to a network 204. Through this coupling, the imaging-client device 202, and therefore the imaging client (i.e., a user), can be placed in communication with one or more network servers, such as servers 206 and 208. The imaging-client device 202 and network servers 206 and 208 represent any of a wide variety of wired and/or wireless computing devices, such as desktop computers, portable computers, dedicated server computers, multi-processor computing devices, personal-digital assistants (PDAs), mobile telephones, pen-based computers, gaming consoles, and so forth.

The network 204 represents one or more data distribution networks that can be used to communicate data and other information (e.g., control information) between or among various computing devices. Examples for the network 204 include the publicly accessible wide-area network (WAN) commonly known as the Internet, a local-area network (LAN), other public and/or private WANs, and combinations thereof. The network 204 can further include various different types of networks, including wired and/or wireless portions, employing any of a variety of different communications protocols including public and/or proprietary communications protocols.

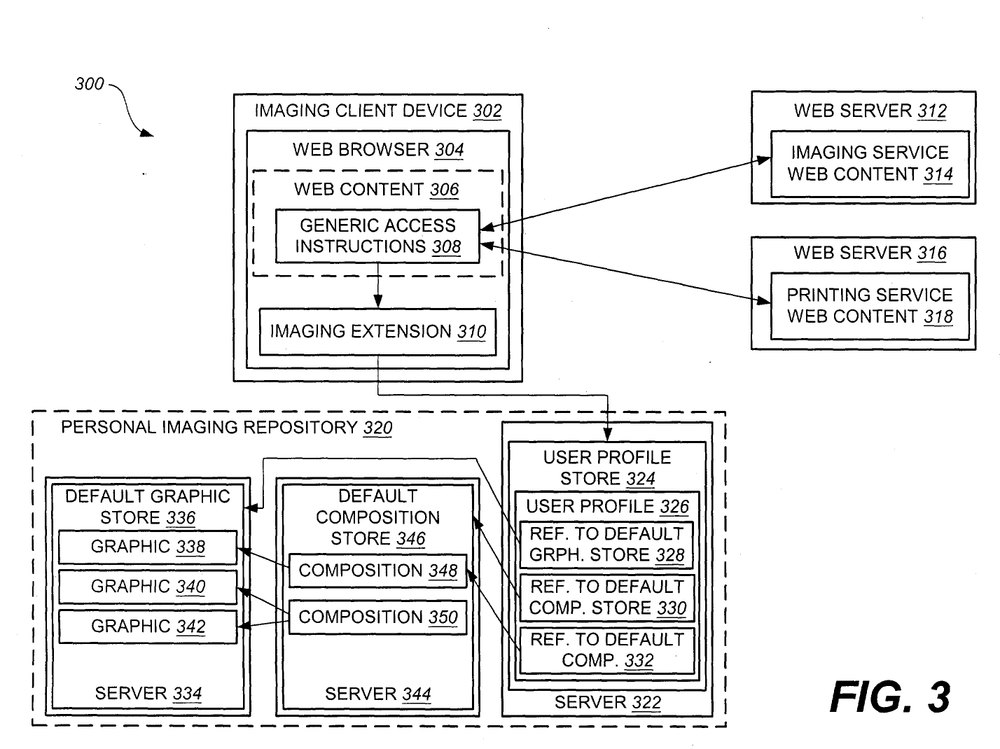

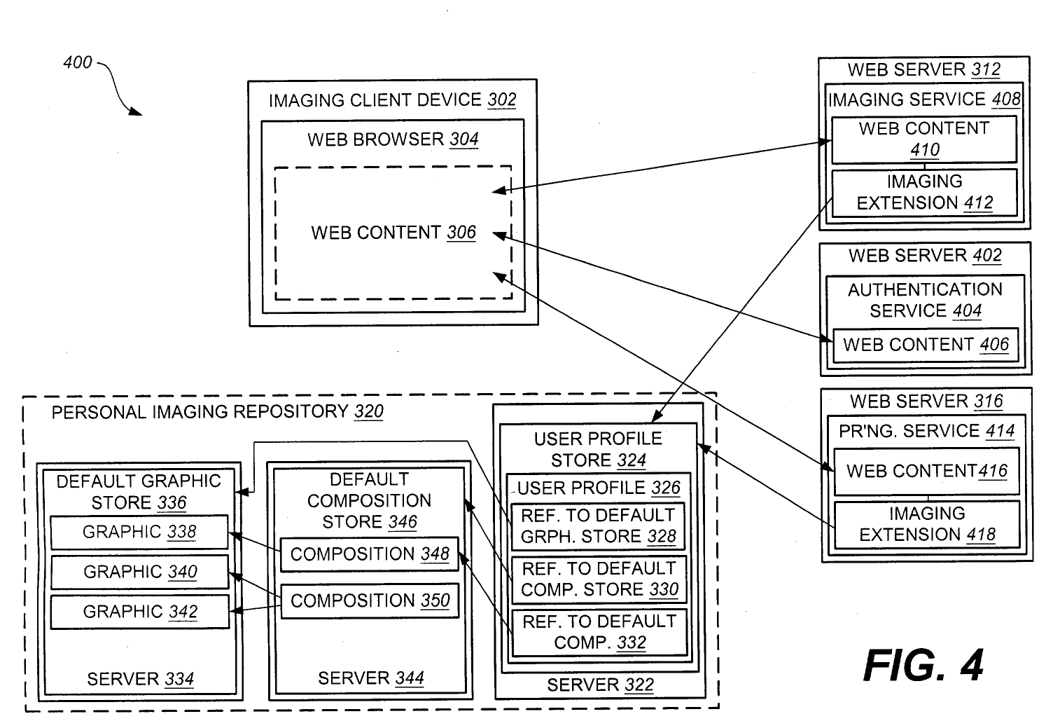

During operation, the user can operate a network browser 210 executing on the imaging-client device 202 to interact with imaging services 216, 218 executing on the network servers 206 and 208, respectively. As used herein, the term “services” refers to software and/or firmware components that can execute on one or more computing devices and which provide one or more particular functions to the imaging-client device 202, such as imaging-data selection and arrangement, data manipulation (including integration of a composition), printing, and others. As indicated in FIG. 2, the network browser 210 can receive network content 212 from one or more of the network servers 206 and 208. This content 212 may include various components such as, for example, text, graphics, commands (e.g., hypertext mark-up language (HTML), Java™, JavaScript™, etc.) and/or applications (e.g., Java™ applets). In use, the content 212 in some arrangements may facilitate communication with a personal-imaging repository 214 so that the servers 206 and 208 can access data stored in the personal-imaging repository 214. Examples of the ways in which this communication can be facilitated are described below with reference to FIGS. 3 and 4.

The network server 206 executes an imaging-source service 216 that, among other things, allows the user to interact with his or her personal-imaging repository 214. The imaging-source service 216 may actually provide multiple services that can be accessed by the user. In some embodiments, these services can provide different functions to the user. For instance, one service may be responsible for graphic storage and retrieval, while another service may be responsible for merging graphics in a single document. By accessing these services with the network browser 210, the user can select or identify imaging data that are to be stored as graphics in a graphic store 220 of the personal-imaging repository 214. These graphics can be stored as individual files and generally can comprise any data capable of representation as a two-dimensional graphic. As discussed below, the individual graphics in store 220 can be used as individual images that can be printed or otherwise reproduced on appropriate media, or multiple individual graphics can be compiled together as a single image for printing and/or other methods of generating a hard-copy output.

Irrespective of whether multiple graphics are to be used, the imaging-source service 216 can be used to arrange the graphic(s) on a visual representation of a document to be created. Once the arrangement has been selected, the imaging-source service 216 can store the arrangement as a composition (i.e., a collection of images) in a composition store 222 of the personal-image repository 214. It is to be noted that, although the graphic store 220 and the composition store 222 are illustrated as two separate stores, multiple stores may exist in the system 200 and one or more graphic stores 220 may be combined with one or more composition stores 222 as desired. Additionally, one or more of these stores 220 and 222 may be implemented on the imaging-client device 202, one or more of the servers 206 or 208, or on other designated computing devices (not shown).

Once the graphics and composition have been selected, the image data can be processed or otherwise manipulated by accessing an imaging-destination service 218 that executes on the network server 208. Where one or more hard-copy products are to be generated, this service 218 can comprise a print service with which document(s) can be printed and/or other hard-copy products may be generated. In one such scenario, a print request is communicated to the imaging-destination service 218 and, upon receipt of the print request, the network server 208 interacts with the graphic store 220 and composition store 222 to retrieve the data needed to complete the print job. Once the data are retrieved, the network server 208 interacts with one or more printing devices (not shown) to which the server is coupled (directly or indirectly) to generate the hard-copy document(s).

FIG. 3 illustrates a first exemplar network-based imaging system 300 in which the systems and methods for distributing imaging information can be implemented. As will be appreciated from the discussion that follows, this system 300 can be described as a client-based implementation in that much of the system functionality is provided by a client device. A similar system is described in detail in U.S. patent application Ser. No. ______, entitled “A Method, System and Program Product for Multi-Profile Operations and Expansive Profile Operation,” by Shell Simpson, Ward Foster, and Kris Livingston and bearing Attorney Docket No. 10007690-1, the disclosure of which is hereby incorporated by reference in its entirety into the present disclosure.

As indicated in FIG. 3, the system 300 includes an imaging-client device 302. The imaging-client device 302 comprises a web browser 304 that is adapted to access web content 306 derived from imaging-service web content 314 and printing-service web content 318 of web servers 312 and 316, respectively. The web content 306, like content 212, typically comprises text, graphics, and various commands. The commands can comprise one or more sets of executable instructions that are downloaded (i.e., communicated) to the web browser 304 to perform a service requested by the user. These instructions can be written in any suitable language including, for instance, HTML, Java™, JavaScript™, C-sharp, or other appropriate languages. A variety of different functions can be served by the executable instructions. For example, the web content 306 normally includes executable instructions for causing graphics, i.e. graphics provided by an accessed web site, such as, but not limited to a composition, to be displayed on an input/output device, such as a display monitor in association with the imaging-client device 302.

In the embodiment shown in FIG. 3, the executable instructions are further used to access a personal-imaging repository 320. These instructions typically comprise system-wide generic access instructions 308 that call on an imaging extension 310 to access the personal-imaging repository 320 and perform various web-imaging operations. These instructions 308 are designated as “generic” because they are independent of the configuration of the user's personal-imaging repository 320. As discussed in greater detail below, the generic-access instructions 308 can be used to, for example, add a graphic, such as a composition, to a default-graphic store 336 of the personal-imaging repository 320, or add a new composition to a default-composition store 346 of the personal-imaging repository 320.

As is further indicated in FIG. 3, the imaging extension 310 can form part of the web browser 304. Although this arrangement is shown in the figure and described herein, the imaging extension 310 can, alternatively, be provided outside of the web browser 304, for instance on a different device. Irrespective of its location, however, the imaging extension 310 is configured to respond to the execution of the generic access instructions 308 by generating and/or mapping corresponding imaging client specific commands entered by the user. The imaging extension 310 typically is implemented as one or more application-programming instructions (APIs) that, preferably, act as interfaces in accordance with a system-wide standard.

When executed, the generic-access instructions 308 cause imaging-extension calls (e.g., API calls) to be issued, which in turn, cause the imaging extension 310 (e.g., APIs) to access the user's personal-imaging repository 320. The web content 306 therefore uses the imaging extension 310 as a gateway to access the user's personal-imaging repository 320. Generally, the APIs can comprise sets of methods for establishing a destination for redirecting the web browser 304 based on some form of received redirection initiation. In such circumstances, the process normally comprises receiving a redirection initiation to redirect the web browser 304, retrieving a direct or indirect reference to a destination, and then causing the web browser 304 to extract information from that particular destination. It will be recognized that there are many other ways (both in hardware and software) to implement this function.

In some arrangements, the imaging extension 310 is configured to prevent the web content 306 (i.e., the executable instructions from one or more web services), from arbitrarily accessing the user's personal-imaging repository 320. This restricted access can be imposed upon the web content 306 using a variety of methods. For example, an imaging extension API can be configured to only accept references from the web content 306 that were previously provided by the imaging extension 310. In such a scenario, the content 306 cannot arbitrarily supply references when calling the imaging extension API. Therefore, to access the user's personal-imaging repository 320, the web content 306 must first obtain references using the imaging extension API.

The imaging extension 310 can be used to access one or more user profiles 326 that is/are stored in a user-profile store 324 of a server 322 of the personal-imaging repository 320. By way of example, the imaging extension 310 can be directed to the user profile 326 with a uniform-resource locator (URL), pointer, socket, or other detail. In some embodiments, the same user can have multiple user profiles. This may be particularly advantageous when a firewall (not shown) is encountered. When firewalls are encountered, different graphic stores and composition stores can be accessed depending on the location of the firewall in relation to the various stores and a communicating node.

The user profile 326 typically includes references to all or a portion of the personal-imaging repository 320 for that user profile. For instance, as shown in FIG. 3, the user profile 326 can include a reference 328 to a default-graphic store, a reference 330 to a default-composition store, and a reference 332 to a default composition. In use, the user-profile store 324 functions as a service that uses appropriate methods to create, modify, access, and cancel profiles. Accordingly, the imaging extension 310 maps to the appropriate methods (i.e., makes use of the methods) in the user profile 326 to obtain the reference to various repository items such as the default-graphic store 336 and the default-composition store 346.

Like the user-profile store 324, the default-graphic store 336 and default-composition store 346 can reside on separate servers 334 and 344. It will be understood, however, that one or more of the stores could reside on a single machine, if desired. As indicated in FIG. 3, the default-graphic store 336 is used to store various graphics, such as graphics 338, 340, and 342. These graphics can be stored in substantially any format. For example, these formats (i.e., file extensions) can comprise PDF, JPEG, PostScript, TIFF, GIF, BMP, etc. In addition, the default-graphic store 336 can include a programming interface consisting of a number of methods. Because the default-graphic store 336 is implemented as a network service, these methods would be accessible through some sort of remote-invocation technology such as a remote- procedure call (RPC), a simple object-access protocol (SOAP), a common-object request-broker architecture (CORBA), a distributed-component object model (DOOM), or others. Therefore, in contrast to merely providing for graphic storage, the graphic store 336 can also provide services used to create, retrieve, and/or manipulate graphics. These services may include a user interface for integrating various images as compositions with target images stored within the graphics store 336. Furthermore, the default-graphic store 336 can communicate with the web content of various web services. For example, printing-service web content 318 can submit queries to the default-graphic store 336 (via the extension 310) about a print job, as well as request that one or more graphics be transmitted in a desired arrangement to optimize printing performance. In some circumstances, the request may include a request for a composition (i.e., a collection of images) as well as a target image.

The default-composition store 346 stores various compositions, such as compositions, 348 and 350, which can be used to arrange the selected graphics. Like the user-profile store 324 and default-graphic store 336, the default-composition store 346 can also comprise various programming interfaces consisting of a number of methods that can be used to access graphics from the graphic store, manipulate the graphics, etc.

FIG. 4 illustrates a second exemplar network-based imaging system 400 in which the systems and methods for distributing imaging information can be realized. As indicated in FIG. 4, the system 400 includes many of the features of the system 300 shown in FIG. 3. Therefore, the system 400 includes an imaging-client device 302 that executes a web browser 304 to receive web content 306. The system 400 also includes a personal-imaging repository 320 that for example, can include a user-profile store 324, a default-graphic store 336, and a default-composition store 346. Furthermore, the system 400 includes web servers 312 and 316. Each of these components is generally configured in a similar manner as the like-named and numbered features identified in FIG. 3. However, unlike the client-based system 300, the system 400 provides a server-based implementation in which many of the functions provided by the client device 302 in the system 300 are transferred to another device. By way of example, this other device can comprise an additional web server 402, which executes an authentication service 404. As shown in FIG. 4, the authentication service 404 comprises web content 406 that can be downloaded into the user's browser 304.

In addition to the above-noted differences, the servers 312 and 316 are provided with different software in the system 400 to permit alternative modes of operation. By way of example, the web server 312 can execute an imaging service 408, which includes web content 410 and an imaging extension 412. Similarly, the web server 316 can execute a printing service 414 that includes web content 416 and an imaging extension 418. Like the web content 314 and 318 of the system 300, the web content 410 and web content 416 typically comprise text and graphics that can be downloaded into the user's browser 304. Unlike the system 300, however, generic-access instructions need not be downloaded into the browser 304 in that the browser does not comprise its own imaging extension. Such an arrangement is advantageous where the imaging-client device 302 has limited storage capacity (e.g., for PDAs, mobile telephones, and other similar devices). Instead, as identified above, the services 408 and 414 include their own imaging extensions 412 and 418, respectively, that can be used to access the user's personal-imaging repository 320. By way of example, the web content 410 and 416 comprise server-side code including one or more of personal-home page (PHP) or personal-home page hypertext-preprocessor scripts, Java™ Servers, Java™ server pages (JSPs), active-server pages (ASPs), etc.

Each of the imaging extensions 412 and 418 typically has configurations that are similar to that of the imaging extension 310 (FIG. 3). Therefore, the imaging extensions 412 and 418 can comprise one or more programmatic interfaces that include one or more methods that, when invoked, access the user's personal-imaging repository 320. Again, the programmatic interfaces can comprise sets of methods for establishing a destination for redirecting the browser 304 based on some form of received redirection initiation. The programmatic interface can include methods that return or make use of, for instance, a URL, pointer, socket, or other detail to facilitate the redirection.

The manner in which the personal-imaging repository 320 is accessed by the services in the system 400 will now be discussed with reference to an exemplar scenario. In this example, the user browses to the imaging service 408 using the web browser 304 of the imaging-client device 302. Upon reaching the service 408, web content 410 is executed to generate web pages that are downloaded to the web browser 304 (as content 306).

For the purposes of this application, a web page refers both to data that is executed within the web server to generate data to be downloaded to the browser, as well as data that is downloaded to and executes within the browser. Presently, the art fails to distinguish between different stages of web-page generation. The terms “server-side” and “client-side,” however, are often used to distinguish where web page related execution occurs. Once the content 306 is received, the browser 304 is redirected by the content 306 to the authentication service 404 that resides on the web server 402. Typically, this is accomplished by the web content 410 through the creation of a hypertext-transfer protocol (HTTP) redirect that when downloaded to the browser 304, causes the browser to redirect to an address (e.g., URL) identified in the header entry. Web content 410 is then downloaded to the web browser 304 and the user is provided with an opportunity to complete an authentication procedure that identifies both the user's identity and the location of the user's personal-imaging repository 320.

The authentication procedure can, for example, comprise entry of authentication information, such as a user name and password that have been registered with the authentication service 404, for example, in a previous session. This information can be entered in a web page generated by the web server 402. In an alternative arrangement, the authentication procedure can comprise the reading of a user-identification card, which includes storage media (e.g., magnetic strip) that contains the user's authentication information. Persons having ordinary skill in the art will recognize that many other authentication alternatives exist that may be integrated with the systems and methods for distributing imaging information.

Once the user successfully completes the authentication procedure, the browser 304 is again redirected, this time back to the imaging service 408. The redirection address (e.g., URL) directs the web browser 304 back to the imaging service 408 and may contain information that identifies the user and the user's personal-imaging repository 320 (e.g., with a further URL). To avoid continual redirection back and forth, a “cookie” can be stored on the imaging-client device 302 that permits the authentication service 404 to validate the user's identity without requiring a further log in. Note that the use of a “cookie” by the authentication service does not eliminate redirection between the imaging service and an authentication service. Such a “cookie” merely eliminates the need to query the user for identification information. A “cookie” could be used by the imaging service to avoid redirection to the authentication services. Once the user's identity information is possessed by the imaging service 408, the service can, when appropriate, make calls to its imaging extension 412 (e.g., programmatic-interface calls) to command the imaging extension to access the user-profile store 324 of the personal-imaging repository 320. Through this access, the imaging service 408 can be used by the user to, for instance, select or identify imaging data to be stored as graphics in the default-graphic store 336.

When the printing service 414 is accessed, for example through redirection from the imaging service 408, as when a “print” button is selected, various content is downloaded to the web browser 304. The printing service 414 can then access the default-graphic store 336 and default-composition store 346 such that the graphics to be printed can be accessed and an intended arrangement of the document obtained. Although the default-graphic store 336 and default-composition store 346 may be accessed, typically a destination service such as printing service 414 accesses the default composition from the user profile. The default composition determines which graphics are accessed. The default composition may or may not refer to a composition that is located in the default-composition store 346.

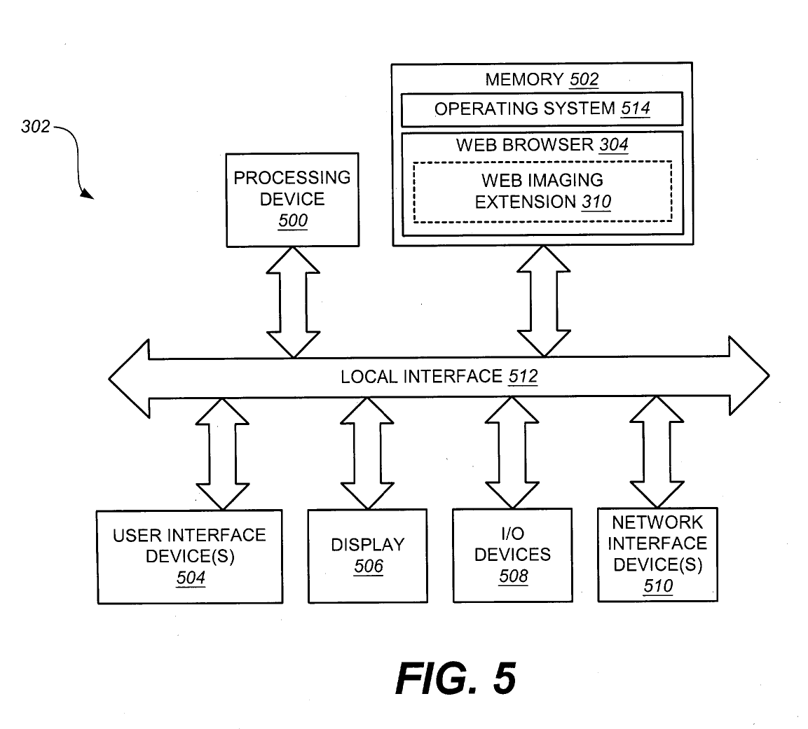

Reference is now directed to FIG. 5, which presents a schematic view illustrating an exemplar architecture of the imaging-client device 302 introduced in FIGS. 3 and 4. As identified above, the client device 302 can be any one of a variety of computing devices, such as desktop computers, portable computers, dedicated server computers, multi-processor computing devices, cellular telephones, PDAs, handheld or pen-based computers, gaming consoles, and others. Irrespective of its type, the client device 302 typically comprises a processing device 500, memory 502, one or more user-interface devices 504, a display 506, one or more input/output (I/O) devices 508, and one or more network-interface devices 510, each of which is connected to a local interface 512.

The local interface 512 can be, but is not limited to, one or more buses or other wired or wireless connections as is known in the art. The local interface 512 may have additional elements, such as buffers (caches), drivers, and controllers (omitted here for simplicity), to enable communications. Further, the local interface 512 includes address, control, and data connections to enable appropriate communications among the aforementioned components.

The processing device 500 can include any custom made or commercially available processor, a central processing unit (CPU) or an auxiliary processor among several processors associated with the client device 302, a semiconductor-based microprocessor (in the form of a microchip), a macro-processor, one or more application-specific integrated circuits (ASICs), a plurality of suitably configured digital-logic gates, and other well known electrical configurations comprising discrete elements both individually and in various combinations to coordinate the overall operation of the imaging-client device 302. The memory 502 can include any one of a combination of volatile-memory elements (e.g., random-access memory (RAM, such as DRAM, SRAM, etc.)) and nonvolatile-memory elements (e.g., ROM, hard drive, tape, CD-ROM, etc.).

The one or more user-interface devices 504 comprise those components with which the user can interact with the imaging-client device 302. For example, where the imaging-client device 302 comprises a personal computer (PC), these components can comprise a keyboard, a mouse, a joystick, etc. Where the imaging-client device 302 comprises a handheld device (e.g., PDA, mobile telephone), these components can comprise function keys or buttons, a touch-sensitive screen, a stylus, etc. The display 506 can comprise a computer monitor or plasma screen for a PC or a liquid crystal display (LCD) for a handheld device.

With further reference to FIG. 5, the one or more I/O devices 508 are adapted to facilitate connection of the client device 302 to another device and may therefore include one or more serial, parallel, small computer-system interface (SCSI), universal-serial bus (USB), IEEE 1394 (e.g., Firewire™), and/or personal-area network (PAN) components. The network-interface devices 510 comprise the various components used to transmit and/or receive data over a network (e.g., network 204 in FIG. 2). By way of example, the network-interface devices 510 include a device that can communicate both inputs and outputs, for instance, a modulator/demodulator (e.g., modem), a wireless (e.g., radio frequency (RF)) transceiver, a telephonic interface, a bridge, a router, a network card, etc.

The memory 502 generally comprises an operating system 514 and a web browser 304. The operating system 514 controls the execution of other software and provides scheduling, input-output control, file and data management, memory management, and communication control and related services. As noted above with reference to FIGS. 3 and 4, the web browser 304 comprises software and/or firmware that is used to access various services over a network (e.g., Internet) and, therefore, download content from various different sources (e.g., imaging-service web content 314, printing-service web content 318, web content 406, 410, and 416, etc.). Where the web browser 304 is configured as indicated in FIG. 3, the web browser 304 can comprise an imaging extension 310. However, it will be understood that where the system is arranged as indicated in FIG. 4, the imaging extension 310 need not be provided in the web browser 304.

The architecture of the various servers shown in FIGS. 3 and 4 are typically similar to that described above with reference to FIG. 5. Therefore, separate figures are not provided for these servers. However, persons having ordinary skill in the art will recognize that various architectures could be used to realize the servers.

The various software and/or firmware described above can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction-execution system, apparatus, or device, such as a computer-based system, processor-containing system, or other system that can fetch the instructions from the instruction-execution system, apparatus, or device and execute the instructions. In the context of this document, a “computer-readable medium” can be any means that can store, communicate, propagate, or transport the program for use by or in connection with the instruction-execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable-computer diskette, a random-access memory (RAM), a read-only memory (ROM), an erasable-programmable read-only memory (EPROM), an electrically erasable-programmable read-only memory (EEPROM), or Flash memory), an optical fiber, and a portable compact-disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

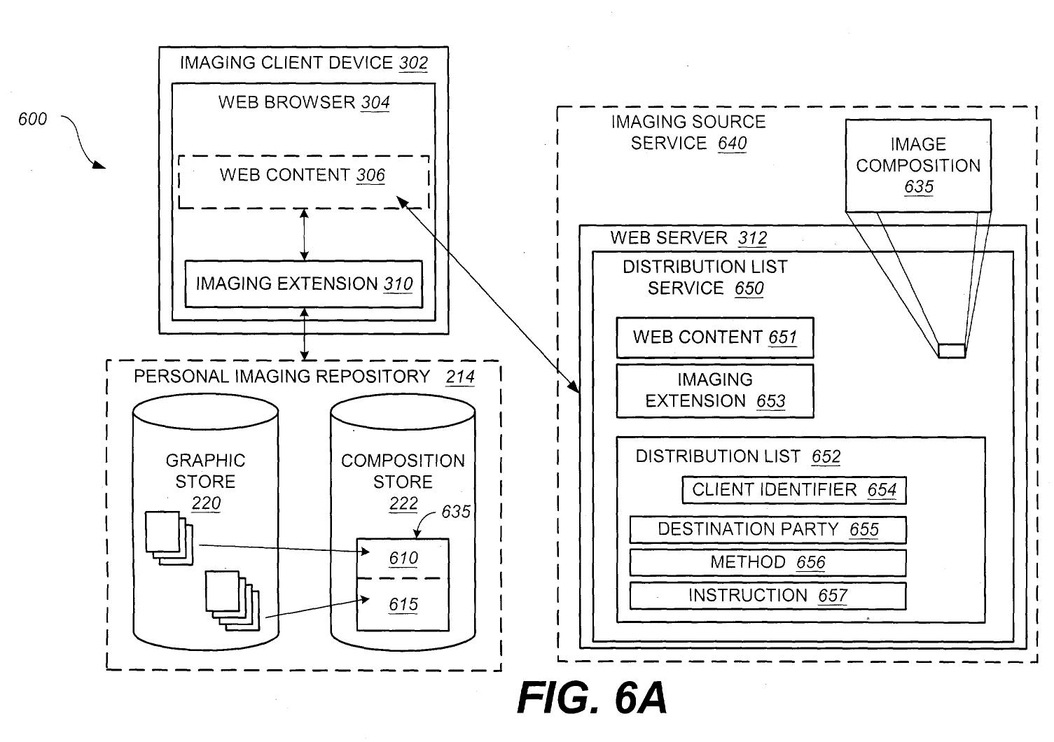

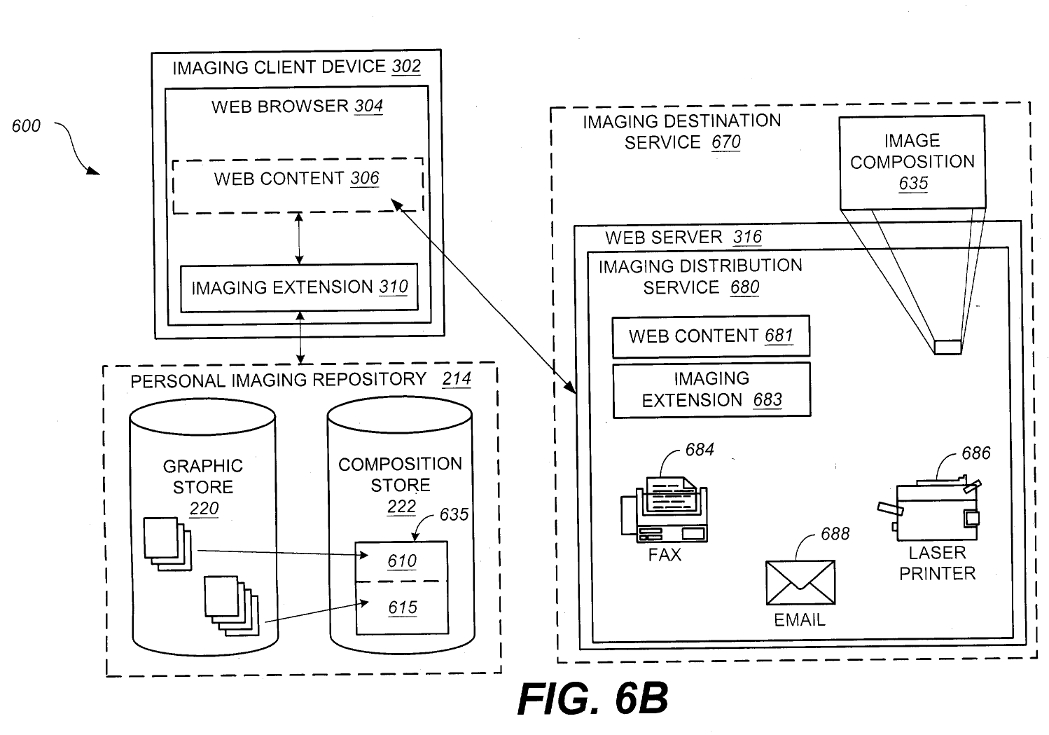

FIGS. 6A and 6B illustrate an embodiment of an imaging system 600. The functional block diagram presented in FIG. 6A shows the imaging-client device 302 and personal-imaging repository 214 in communication with an imaging-source service 640. It should be appreciated that as in the previously illustrated and described systems, the imaging-client device 302, personal-imaging repository 214, and imaging-source service 640 communicate with other via a network (not shown for simplicity of illustration). As illustrated in FIG. 6A, the imaging-source service 640 may comprise a web server 312 containing logic configured to enable a distribution-list service 650.

The distribution-list service 650, as illustrated in the functional block diagram may comprise web content 651 and an imaging extension 653. As in previously illustrated and described embodiments of imaging-source services, the web content 651 and imaging extension 653 allow the distribution-list service 650 to receive one or more references defining image composition 635. In this embodiment, the distribution-list service 650 is configured to receive information provided by a client via the imaging-client device 302. In this regard, the client (i.e., a user of the imaging-client device 302) forwards information for generating a distribution list 652.

As illustrated, the information may include a client identifier 654, a destination party 655, a preferred method for delivering the data identified by the image composition 635, as well as special instructions 657 that may be necessary based on the destination party 655 and/or the desired delivery method 656. Alternatively, the distribution list 652 may contain one or more image compositions 635 or an identifier that can be used by subsequent services to locate and use the image composition 635.

The distribution-list service 650 after having received the information from the client, may be programmed to generate a distribution list 652 which may be applied by logic within the distribution-list service 650 to forward the content of a designated image composition to a plurality of destination parties 655 via a plurality of delivery methods 656. It should be appreciated that the distribution-list service 650 may be programmed to interactively construct a client-directed distribution list 652. Alternatively, the distribution-list service 650 may be programmed to accept a database file, a flat file, or other similar data structures previously generated and stored either within the imaging-client device 302 or the client's personal-imaging repository 214.

The distribution list 652, once created by the distribution-list service 650, may be forwarded, stored, or returned to the client for subsequent use. The client, capable of accessing the personalized distribution list 652, may then direct any number of image-data transfers using the imaging system 600. The functional block diagram illustrated in FIG. 6B demonstrates some alternative delivery methods that may be implemented by an imaging-distribution service 680.

The functional block diagram presented in FIG. 6B shows the imaging-client device 302 and personal-imaging repository 214 in communication with an imaging-destination service 670. The imaging-client device 302, personal-imaging repository 214, and imaging-destination service 670 communicate with other via a network (not shown for simplicity of illustration). As illustrated in FIG. 6B, the imaging-destination service 670 may comprise a web server 316 containing logic configured to enable the imaging-distribution service 680.

The imaging-distribution service 680, as illustrated in the functional block diagram may comprise web content 681 and an imaging extension 683, as well as a plurality of communication mechanisms such as but not limited to, a fax machine 684, a printer 686, and an email engine 688. As in previously illustrated and described embodiments of imaging-destination services, the web content 681 and imaging extension 683 allow the imaging-distribution service 680 to receive one or more references defining image composition 635. As previously described, one or more image compositions 635 may be defined in the distribution-list 652 created by the distribution-list service 650 of FIG. 6A. The distribution list 652, having been communicated to the imaging-distribution service 680 may be used by the imaging-distribution service 680 to direct client instructed delivery of the data referenced in the one or more image compositions 635.

In the sample imaging-distribution service 680 illustrated in the functional block diagram of FIG. 6B, the client has the capability to direct the delivery of image data identified in image composition 635 via facsimile 684, email 688, and direct printing via a network-coupled printer 686. While, the illustrated embodiment reveals these specific devices, those skilled in the art will appreciate that a suitably configured personal computer (PC) communicatively coupled to the imaging-distribution service 680 may be used as the mechanism for delivering specified instances of the underlying information identified by the image composition 635. It should be further appreciated that the imaging-distribution service 680 is not limited to the illustrated distribution methods. For example, the imaging-distribution service 680 may be configured to prepare an addressed envelope complete with indicia of having rendered the necessary postage for the U.S. mail service to deliver the message. In other embodiments, the imaging-distribution service 680 may be programmed to generate courier specific invoices in order to prepare the underlying content for delivery via a preferred commercial courier along with a preferred service level.

In operation, the imaging-distribution service 680 may in accordance with the identified destination party 655, the destination method 656 and any special instructions 657 prepare and deliver the underlying content of the image composition 635. For example, a dentist may desire to remind clients of a previously arranged appointment. The dentist, via his imaging-client device 302 may forward a distribution list 652 containing information identifying herself (i.e., the client identifier 654), each client that has an appointment scheduled on a specific day, each patient's preferred method 656 for receiving appointment reminders and an instruction 657 to send the message during non-business hours.

At the designated time, or alternatively at a time offset from a target delivery time noted in the instruction 657, the imaging-distribution service 680 formats the appointment reminder in accordance with the identified destination party 655 and method 656 and forwards the reminder. The reminder message may comprise information referenced in image composition 635 which, in this example, may include the dentist's contact information, the appointment date and time, and perhaps a brief note indicating what services the dentist intends to provide during the appointment. While the client cannot control the quality of the patient's received message, the client can control both how and when appointment reminders are distributed. Because an image composition 635 is used in formulating the delivered message, the client may add maps of office locations, advertising, coupons for related goods and services and the like to the various messages.

In some embodiments, the composition 635 including its component parts may be added and/or otherwise identified as a “preferred” or “default” composition. A “default” composition is a reference to the composition designated to be used by the imaging system. In some embodiments, the default composition will reference the last created composition. This composition may contain references to a particular document, photograph, and perhaps, other images. The default composition solves the problem of identifying which of the available compositions to choose.

Note that automatically selecting the default composition does not preclude selecting another composition. The default composition is simply the composition identified by a value stored in the user's profile. This value contains a reference to the composition designated to be the default composition (by virtue of the value of the default composition reference) and can be located anywhere on the network. Note further that the default composition is not necessarily located in the default-composition store. Because the composition may be a conglomeration of multiple images, the user can initiate a data transfer from any node in communication with the personal-imaging repository 214 regardless of whether the communicating device understands documents, photographs, designs, etc. Moreover, the client can identify a destination service for processing the “default” composition without having to confirm that the destination device is configured with appropriate software and/or firmware to complete the request.

In addition, the content format can be negotiated. The graphic store might have the ability to supply the imaging data in a variety of formats. The composition store, similarly, might have the ability to take the content supplied by the various content stores and make additional modifications to the file format. Finally, the imaging source might have the capacity to accept a variety of formats. For example, this format negotiation can be accomplished by the destination service (which knows what formats it supports) interrogating the source service (i.e., the composition store) for formats that the source service supports, and then choosing what one or the other services identifies as an appropriate format for the data transfer.

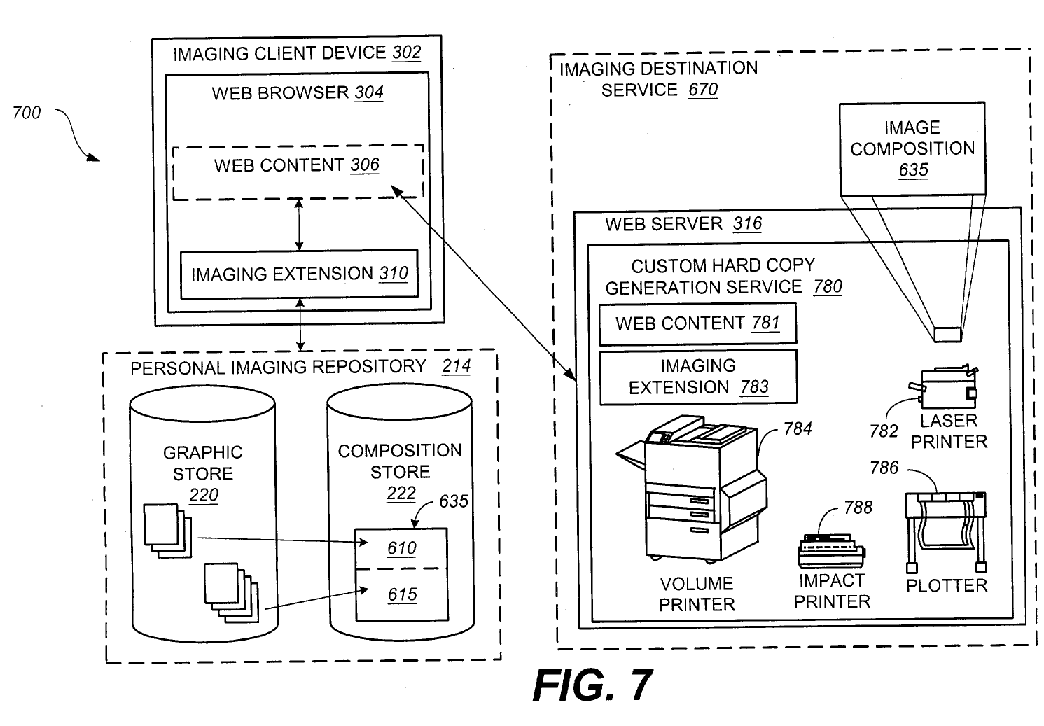

The functional block diagram presented in FIG. 7 shows the imaging-client device 302 and personal-imaging repository 214 in communication with another embodiment of an imaging-destination service 670. The imaging-client device 302, personal-imaging repository 214, and imaging-destination service 670 communicate with other via a network (not shown for simplicity of illustration). As illustrated in FIG. 7, the imaging-destination service 670 may comprise a web server 316 containing logic configured to enable a custom-hard-copy-generation service 780.

The custom-hard-copy-generation service 780, as illustrated in the functional block diagram may comprise web content 781 and an imaging extension 783, as well as a plurality of hard-copy-generation devices, such as but not limited to, a laser printer 782, a high volume printer 784, a plotter 786, and an impact printer 788. As in previously illustrated and described embodiments of imaging-destination services, the web content 781 and imaging extension 783 allow the custom-hard-copy-generation service 780 to receive one or more references defining image composition 635. As also previously described, one or more image compositions 635 may be defined in the web content 781. The image composition 635 (and any ancillary instruction), having been communicated to the custom-hard-copy-generation service 780 may be used by the custom-hard-copy-generation service 780 to direct client instructed delivery and/or “on-demand” printing at remote sites of the data referenced in the one or more image compositions 635.

In this way, each remote site does not have to retain an inventory of each hardcopy product that it may require in the course of business. Note that hard-copy products are not limited to marketing items intended for distribution but may include internal operations manuals, technical support documentation, and similar materials. Generally, an employee only requires a small portion of these internal materials. The custom-hard-copy-generation service 780 permits each employee to selectively print the latest version of those materials that may assist the employee in completing a specified task.

In the sample custom-hard-copy-generation service 780 illustrated in the functional block diagram of FIG. 7, the client has the capability to direct the delivery of image-data identified in image composition 635 via laser printer 782, volume printer 784, plotter 786, and impact printer 788 among other hard-copy generation devices not shown. Significantly, remote business sites in close proximity to the custom-hard-copy generation service 780 may direct the on-demand generation of a brochure, an operating manual, marketing materials, centrally controlled and distributed office forms, and the like. In this way, an enterprise would no longer have the burden of storing and managing inventories of these hard-copy items.

While the illustrated embodiment and the description above implies that the various printing devices are located together, alternative embodiments may strategically distribute the various printing devices. For example, various low-cost and easy to maintain printing devices may be placed within a plurality of customer sites communicatively coupled to the web server 316. Conversely, relatively high-cost and/or high-maintenance products may be located in geographically distributed branches thereby permitting an enterprise to still take advantage of economies of scale while balancing the desire of “on-demand” products.

When a branch office runs out of copies of a particular item, a remote requester (i.e., a user of the computing device hosting web server 316 or another computing device in communication with one of the computing devices in the imaging system 700) may identify the required item and designate the number of copies desired to the imaging-client device 302. The imaging-client device 302 may then forward an image composition 635 that contains a reference to the images that may be used to formulate the final product to the custom-hard-copy generation service 780 along with other instructions as may be desired. In turn, the custom-hard-copy generation service 780 may in accordance with the instructions and the underlying content of the image composition 635 generate the desired item.

For example, an automobile dealership requires a supply of marketing brochures and user's manuals for each model car and model year that they offer for sale. In addition, the sale of automobiles requires multiple forms. Each dealer has no way of knowing from year to year which vehicle models will peak the interest of potential buyers. Rather than produce and inventory marketing brochures in arbitrary amounts, each individual dealer has the flexibility to order marketing materials (after receiving some level of inventory) as it appears that the dealership will need them. It should be appreciated that the high-quality desired in marketing brochures may necessitate that an automobile company produces these items at geographically centered regional print centers. When it is the case that marketing brochures are printed at a central location the printing may be performed in strategically located regional centers to minimize shipping costs associated with distributing the printed materials.

In addition to requiring a supply of marketing materials for each model offered for sale, a dealership may provide a user's manual with each new vehicle sold. While a dealership may be able to predict how many units of a particular vehicle they will sell in a given model year, and thus be able to predict their need for a particular user's manual, the custom-bard-copy generation service 780 allows each individual dealer more control in how it orders and manages its inventory of user's manuals.

In the course of selling vehicles, an automobile dealer processes multiple forms. These multiple forms may include sales contracts, leasing agreements, title applications for multiple states, as well as financing applications. The custom-hard-copy generation service 780 illustrated in FIG. 7, permits each maker of automobiles to flexibly control each form used among its various dealers.

As desired, a forms manager can direct the custom-hard-copy generation service 780 to begin a production run of a new form or a modified version of an old form. As illustrated in FIG. 7, the forms manager can use the imaging-client device 302 to forward the appropriate image composition 635 that will enable one or more of the print devices associated with the custom-hard-copy generation service 780 to produce the desired number of copies of the form. When it is the case that the printing device is located within a particular dealership, the dealership will be able to start using the new or modified form almost immediately.

In the case where a remote office is equipped with a printing device capable of retaining print jobs, network-based imaging techniques may be used by a centralized or corporate level forms manager to ensure that each remote site receives and retains the latest version of each form required by the remote office. Network-based imaging techniques can be used during off peak (i.e., non-business hours) to periodically update one or more printing devices configured to retain print jobs. Once they are updated with the appropriate forms, the printing devices are capable of responding to local-user requests for specific forms.

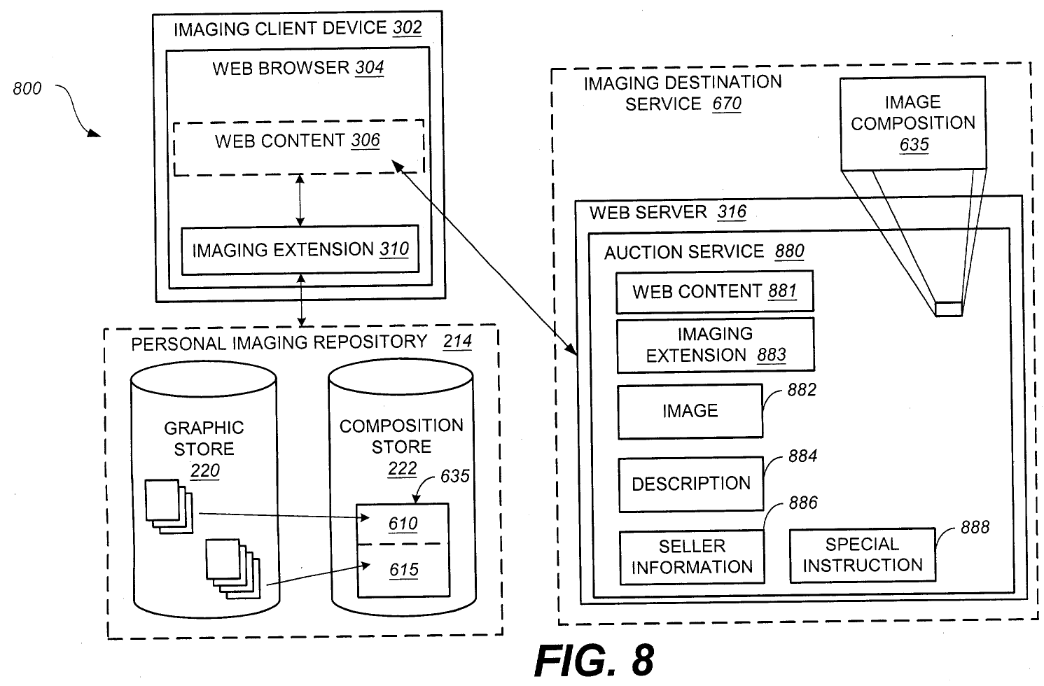

Reference is now directed to FIG. 8. The functional block diagram presented in FIG. 8, shows the imaging-client device 302 and personal-imaging repository 214 in communication with another embodiment of an imaging-destination service 670. The imaging-client device 302, personal-imaging repository 214, and imaging-destination destination service 670 communicate with other via a network (not shown for simplicity of illustration). As illustrated in FIG. 8, the imaging-destination service 670 may comprise a web server 316 containing logic configured to enable an auction service 880.

The auction service 880, as illustrated in the diagram may comprise web content 881 and an imaging extension 883, as well as an image 882, an item description 884, seller information 886, and special instruction 888. As in previously illustrated and described embodiments of imaging-destination services 670, the web content 881 and imaging extension 883 allow the auction service 880 to receive one or more references defining image composition 635. As also previously described, one or more image compositions 635 may be defined by the web content 881. The image composition 635 (and any ancillary instruction), having been communicated to the auction service 880 may be used by the service to direct client initiated delivery of images and descriptions to those interested in purchasing an item.

In the sample embodiment of an auction service 880 illustrated in the functional block diagram of FIG. 8, the client has the capability to direct the delivery of image-data identified in image composition 635 via web content 306 to the auction service 880. The auction service 880 then has the option to store a reference (i.e., the image composition 635) or alternatively produce a copy of the image 882 for storage and integration with the auction service 880.

As further illustrated in FIG. 8, the auction service 880 may be programmed to receive an item description 884, seller information 886, and special instructions 888. Item description 884 may include name, model number, age of the item, as well as other descriptors. Seller information 886 can include the seller's name, address, preferred method and time for correspondence, as well as a phone number and an email address. Special instructions 888 may include any of a number of seller preferences including when to place the item for auction, whether the auction is to take place with a reserve, etc.

The auction service 880, having received the above-referenced information may integrate the information, categorize the item offered for sale, and display the item and description in register in response to external requests to bid on items in that particular category. The auction service 880 may receive one or more images (e.g., photographs of the item(s) up for bid, as well as a document image containing a written description of the items and possibly auction terms) by reference or by value. An image is received by reference in accordance with previous descriptions of an image composition 635. An image is received by value when the destination device receives an actual copy of the image (as opposed to a reference). When the auction service 880 retains only the image composition 635 (i.e., a reference to the image stored within the client's personal-imaging repository 214) the web content 881 may be programmed to forward an interested user to the location of the actual image data. In this way, the auction service 880 is not required to retain each image (e.g., photograph) submitted with items offered for the auction.

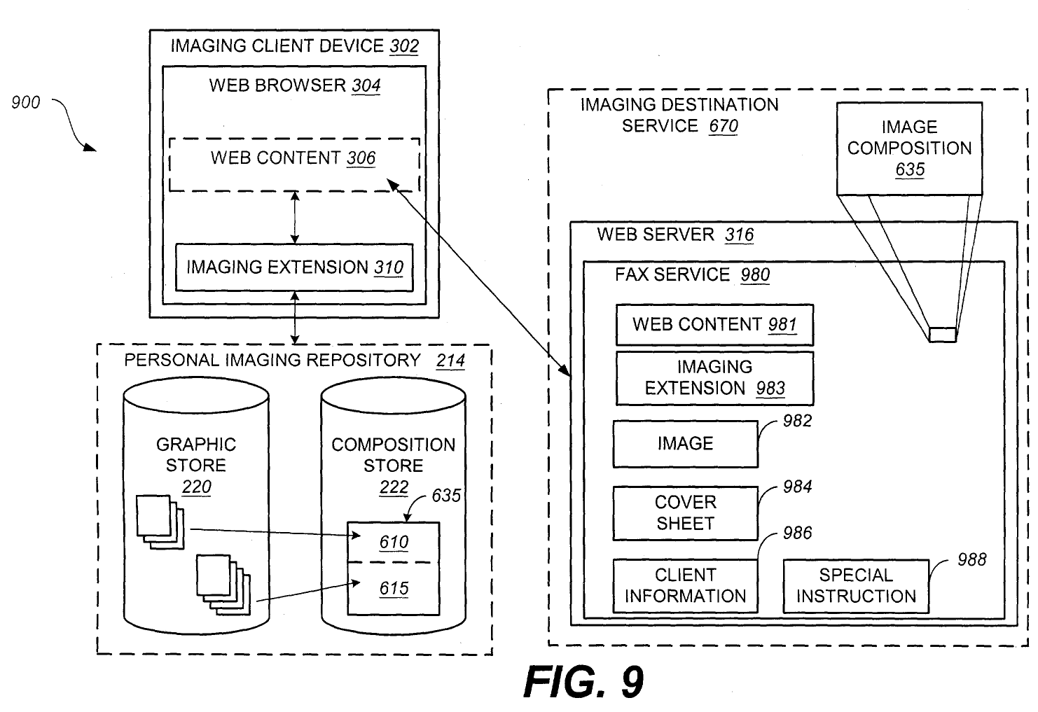

FIG. 9 illustrates another embodiment of an imaging-destination service 670. The imaging-client device 302, personal-imaging repository 214, and imaging-destination service 670, as in the other embodiments, communicate with each other via a network (not shown for simplicity of illustration). As illustrated in FIG. 9, the imaging-destination service 670 may comprise a web server 316 containing logic configured to enable a fax service 980.

The fax service 980, as illustrated in the diagram may comprise web content 981 and an imaging extension 983, as well as an image 982, a cover sheet 984, client information 986, and special instruction 988. As in previously illustrated and described embodiments of imaging-destination services 670, the web content 981 and imaging extension 983 allow the fax service 980 to receive one or more references defining image composition 635. The image composition 635 (and any ancillary information), having been communicated to the fax service 980 may be used by the service to direct client initiated delivery of images via facsimile to one or more designated parties. One mechanism among others that may be used to communicate the requisite information to the fax service 980 is the distribution list 652 illustrated in FIG. 6A.

In the sample embodiment of a fax service 980 illustrated in the functional block diagram of FIG. 9, the client has the capability to direct the delivery of image-data (documents, photographs, etc.) identified in image composition 635 via web content 306 to the fax service 980. As further illustrated in the block diagram, the fax service 980 may be programmed to associate a client specific cover sheet 984 to be forwarded with the underlying message included in image 982.

The client specific cover sheet 984 may be generated by a client interacting with software operative on the imaging-client device 302. Alternatively, the client specific cover sheet 984 may be generated by interacting with an imaging-source service 640 configured to allow a remote user to generate a custom cover sheet. Once the custom cover sheet has been generated, a user interacting with the imaging system 900 via the imaging-client device 302 can select the cover sheet as a default composition. Alternatively, the imaging-source service 640 may be configured to store a copy of the user-generated cover sheet in the user's personal-imaging repository 214. Along with storing the cover sheet, the imaging-source service 640 may also be configured to mark the cover sheet as the user's default cover sheet composition.

The fax service 980 may be programmed to search for a default cover sheet composition identifying the location of the cover sheet 984 within the client's personal-imaging repository 214 and append the image composition 635 to the client's default cover sheet composition to form a facsimile composition. Alternatively, the fax service 980 may be programmed to send the cover sheet 984 as identified in the default cover sheet composition before sending the one or more images referenced in the image composition 635.

As is also shown in the functional block diagram of FIG. 9, the fax service 980 may be programmed to receive client information 986 and special instructions 988. Client information 986 can include the client's name, address, an account number, a preferred method of payment for long distance charges, as well as a preferred time for correspondence, a phone number and an email address. Special instructions 988 may include any of a number of client preferences including when to start attempting to send the message, how many times to redial before reporting a problem, and or attempting a secondary facsimile number, etc.

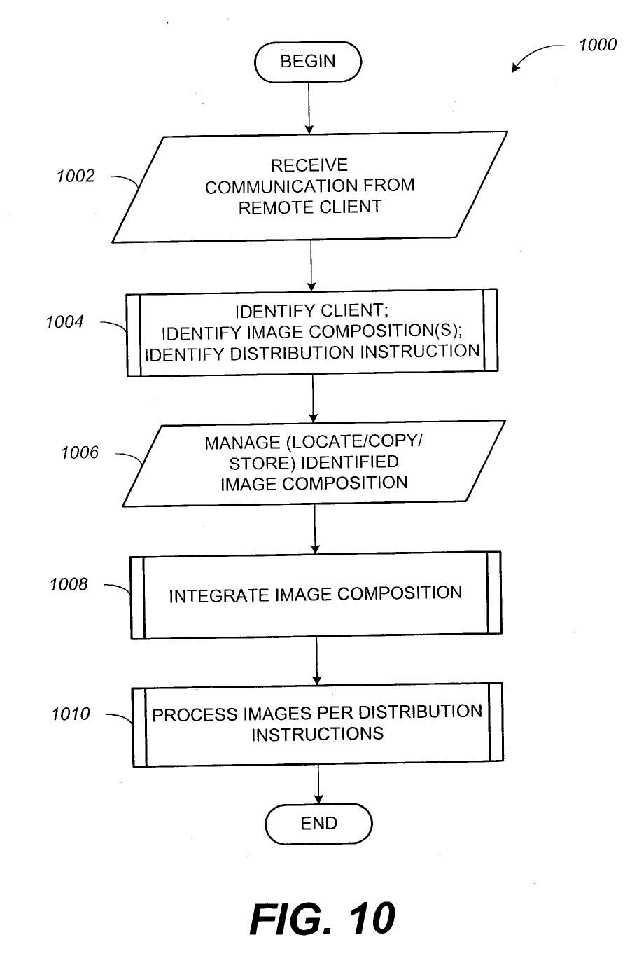

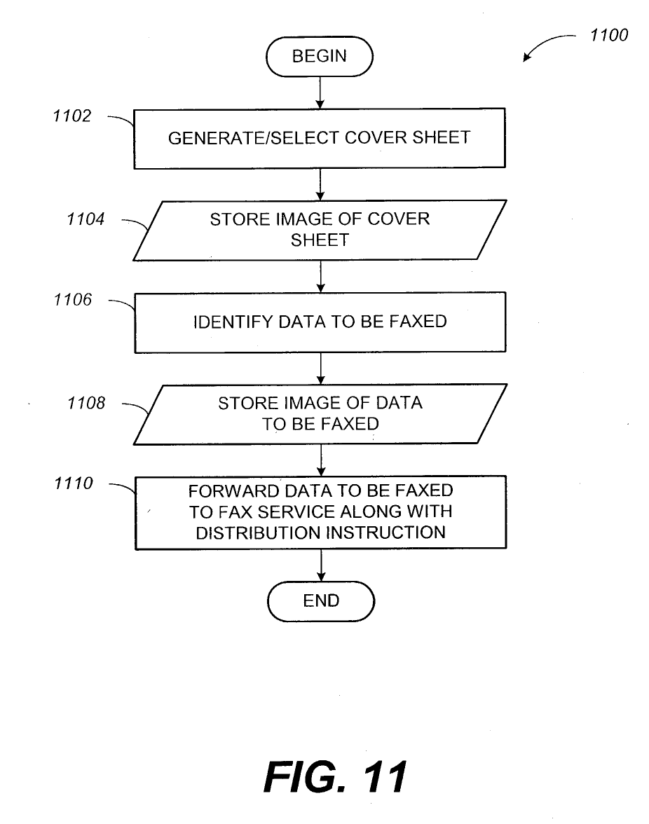

Exemplar systems for distributing imaging information having been described above, a sample method for controllably distributing information using web-based imaging will now be discussed. In this regard, the following discussion describes steps illustrated in the flowchart of FIG. 10. It should be understood that any process steps or blocks in the flowcharts of both FIGS. 10 and 11 may represent modules, segments, or portions of code that include one or more executable instructions for implementing specific logical functions or steps in the associated process. It should be appreciated that although particular process steps are described, alternative implementations are feasible. Moreover, some method steps may be executed out-of-order from that shown or discussed, including substantially concurrently or in reverse order, depending on the functions involved.

Reference is now directed to FIG. 10, which illustrates a method for controllably distributing data that may be practiced by the various imaging systems presented in FIGS. 3-9 above. In this regard, a method for controllably distributing data 100 may begin when an imaging-destination service 218 receives a communication from a remote client as indicated in step 1002. As previously described above, a client may communicate with the imaging-destination service 218 via an imaging-client device 302 configured with a web browser 304 by transferring web content 306 to the imaging-destination service 218. The imaging-destination service 218, having received the communication transferred in step 1002, may be configured to identify the client, identify various image compositions desired to be distributed; and identify one or more distribution instructions. As described above, the distribution instructions may include a distribution list 652 identifying a host of destinations, preferred delivery mechanism for each destination, as well as, individual instruction directing the imaging-destination service 218 how to handle certain conditions that the system may encounter when it is attempting to distribute the identified information referenced by the image compositions.

Next, as illustrated in step 1006, the imaging-destination service 218 may be configured to determine if it can appropriately locate the underlying data referenced in the one or more image compositions to be associated with each distribution request. Note, in some embodiments the imaging-destination service 218 may be configured to simply confirm that the image composition(s) 635 identified by the client are indeed present on a network-coupled data storage device (i.e., a personal-imaging repository) and accessible by the service. In other arrangements, the imaging-destination service 218 may make a copy of one or more of the images identified by the image compositions 635. It should be appreciated that regardless of whether the imaging-destination service 218 makes a copy of the underlying data, the underlying information within the image compositions 635 may be distributed by an appropriately configured imaging-destination service 218 as long as the one or more image compositions 635 are accessible on the network.

As indicated in step 1008, the imaging-destination service 218 may then be configured to integrate the one or more image compositions 635 in accordance with the requirements communicated in the previously received distribution instruction. This data integration may comprise generating a schedule to coordinate the desired sequence of distribution. In other arrangements, the data integration may comprise formulating the necessary device commands to implement a particular data transfer. For example, a distribution list 652 may indicate that a particular party is to be notified of an upcoming engagement via a facsimile message.

After integrating the designated image composition(s) 635 as indicated in step 1008, the imaging-destination service 218 may be configured to process (i.e., manage) the images and a variety of delivery hardware devices to convey the indicated information as shown in step 1010. The imaging-destination service 218 may be configured to reference and/or retrieve a cover sheet identified by the client, as well as copy of a designated image containing the information to be faxed. The imaging-destination service 218 may be further configured to initiate a facsimile message at a designated delivery time. The designated delivery time, as well as further instruction that may include the number of attempts to try before transitioning to a secondary number, may be contained within additional fields in each record of the distribution list 652. As described above, an appropriately configured imaging-destination service 218 may be configured to distribute email and hard-copy products in addition to facsimile messages. As also described above, an appropriately configured imaging-destination service 218 can be used to distribute photographs, document images, related instructions, and the like in association with an auction service.

Reference is now directed to the flow diagram of FIG. 11, which illustrates a method 1100 for generating a facsimile message that can be implemented by the imaging system 900 illustrated in FIG. 9. As illustrated in FIG. 11, the method for generating a facsimile message 1100 may begin with step 1102, where a user of the imaging-client device 302 defines a cover sheet. In some embodiments, the imaging-client device 302 may be configured with suitable hardware, software, and user interfaces to permit an operator to generate a representation of the desired cover sheet. In these embodiments, the user need only select or otherwise identify the image of the desired cover sheet. In alternative embodiments, the imaging-client device 302 may be programmed to interact with an imaging-source service 640 configured to generate fax cover sheets under client direction.

Regardless of the particular generation method, after the client has selected the cover sheet in step 1102, an image of the selected cover sheet may be forwarded and stored in the client's personal-imaging repository as illustrated in step 1104. Alternatively, the image of the cover sheet may be forwarded by reference or by value (i.e., the actual image) to the fax service 980. Note that the cover sheet may contain a number of fields that may contain destination specific information (i.e., the destination phone number, the name of the party, etc.) It should be appreciated that the fax service 980 may be configured to apply destination specific information as images in register with the user specific cover sheet 984.

Once the cover sheet is identified and stored, a user of the imaging-client device 302 may designate various images for forwarding to one or more destination parties via facsimile messages, such as from fax service 980, as shown in step 1106. A user of the imaging-client device 302 may accomplish this designation by forwarding web content 310 via web browser 304 to the fax service 980. As previously described the web content 310 may include an image composition 635 that may be used by the fax service 980 to locate the user's designated message materials (i.e., photographs, documents, as well as other images) in the user's personal-imaging repository 214. Thereafter, as illustrated in step 1108, the fax service 980 may retrieve and store the user-identified document, photograph, or other image(s) that the user desires to send via the service. Once the fax service has retrieved and stored the designated information, the fax service may forward the information in accordance with the associated distribution instruction as indicated in step 1110. The fax service 980 may schedule the facsimile transmission for subsequent distribution or establish an immediate facsimile communication session with a designated fax machine.

It should be emphasized that the above-described embodiments, particularly, any “preferred” embodiments, are merely possible examples of implementations, merely set forth for a clear understanding of the principles of the systems and methods for generating and distributing information. Many variations and modifications may be made to the above-described embodiment(s) of the systems and methods without departing substantially from the principles thereof. These and all other such modifications and variations are intended to be included herein within the scope of this disclosure and the systems and methods for distributing imaging information using network-based imaging techniques as protected and set forth by the following claims.

We claim:

1. A method for distributing imaging information, comprising:
accessing a remote-data server;
identifying an accessible composition;
accessing an imaging-destination service; and
communicating the composition to the imaging-destination service.

2. The method of claim 1, further comprising:
storing the composition such that the composition may be accessed by a plurality of imaging services.

3. The method of claim 1, wherein the step of accessing comprises using an imaging extension.

4. The method of claim 2, wherein storing the composition comprises saving the composition on network-coupled personal-imaging repository.

5. A method for distributing imaging information, comprising:
receiving a communication from a client, the communication including an image composition and distribution instructions;
identifying the location of the component images comprising the image composition; and
distributing the component images comprising the composition in accordance with the distribution instructions.

6. The method of claim 5, further comprising:
integrating the composition within the service such that the composition is accessible.

7. The method of claim 5, wherein receiving a communication comprises using an imaging extension.

8. The method of claim 5, further comprising:
storing the component images comprising the composition within the service such that the composition is accessible.

9. The method of claim 8, wherein the step of storing the component images comprises retaining web content such that a copy of the web content can be forwarded to a communicatively coupled computing device.

10. A system for distributing imaging information, comprising:
means for selecting an image;
means for associating the selected image with a composition; and
means for communicating the composition and distribution instructions to an imaging-destination service.

11. The system of claim 10, wherein the means for selecting comprises an imaging-client device.

12. The system of claim 11, wherein the imaging-client device comprises a browser.

13. The system of claim 12, wherein the browser contains web content, the web content comprising information reflective of the composition.

14. The system of claim 13, wherein the information reflective of the composition is extracted from a network-coupled imaging-source service.

15. The system of claim 10, wherein the means for communicating comprises an imaging extension.

16. The system of claim 15, wherein the imaging extension communicates with a personal-imaging repository.

17. The system of claim 10, wherein the means for associating comprises logic in an imaging extension.

18. A system for distributing image information, comprising:
an imaging-client device coupled to a network, the imaging-client device containing a web browser configured to generate web content, the imaging-client device including logic for managing the contents of a personal-imaging repository, the personal-imaging repository having a graphic store and a composition store; and
a first server coupled to the network, the first server having logic configured to operate an imaging-distribution service, the imaging-distribution service configured to receive the web content, identify a client, an image composition, and distribution instructions, the imaging-distribution service further configured to access at least one image within the personal-imaging repository as identified by the image composition and distribute the image.

19. The system of claim 18, wherein the server delivers the image in accordance with a distribution methods selected from the group consisting of facsimile, email, or printing a hard-copy representation of the image.

20. The system of claim 18, further comprising:
a second server, the second server having logic configured to operate an imaging-source service, the imaging-source service configured to receive web content, identify a client, and generate a distribution list.

21. The system of claim 20, wherein the imaging-distribution service delivers the image in accordance with the distribution list.

22. The system of claim 18, wherein the browser accesses an imaging extension.

23. The system of claim 18, wherein the imaging-distribution service comprises an auction service.

24. The system of claim 18, wherein the imaging-distribution service comprises a hard-copy generation service.

25. The system of claim 24, wherein the hard-copy generation service comprises a printing device capable of retaining a document identified within web content, the printing device configured to generate the document in response to a local user request.

26. The system of claim 18, wherein the imaging-distribution service comprises a facsimile service.

27. A computer program embodied on a computer-readable medium, the computer program, comprising:
logic configured to receive web content from an imaging-client device, the web content comprising a client identifier, an image composition, and a distribution list;
logic configured to extract the client identifier, the image composition, and the distribution list from the web content; and
logic configured to access an image identified by the image composition, the logic further configured to distribute the image in accordance with the distribution list.

28. The program of claim 26, wherein the logic configured to extract comprises an imaging extension.

29. The program of claim 26, wherein the image is stored within a personal-imaging repository.
